(19) United States
(12) Patent Application Publication
(10) Pub. No.: US 2026/0040274 A1
(43) Pub. Date: Feb. 5, 2026

(54) METHOD AND APPARATUS FOR ROBUST SMALL DATA TRANSMISSION IN A WIRELESS NETWORK

(71) Applicant: Continental Automotive Technologies GmbH, Hannover (DE)

(72) Inventors: Rikin Shah, Langen (DE); David Gonzalez Gonzalez, Egelsbach (DE); Hojin Kim, Regensburg (DE)

(73) Assignee: Continental Automotive Technologies GmbH, Hannover (DE)

(21) Appl. No.: 19/100,614

(22) PCT Filed: Aug. 2, 2023
(86) PCT No.: PCT/EP2023/071459

§ 371 Date: Feb. 3, 2025

(30) Foreign Application Priority Data
Aug. 3, 2022 (DE) 10 2022 208 044.0

(51) Int. Cl. H04W 68/00; H04W 74/0833

(52) U.S. Cl. CPC H04W 68/005; H04W 74/085

(57) ABSTRACT

A base station transmits small-data-transmission data to a user equipment. The user equipment is set to an inactive state. The base station provides the small-data-transmission data. The base station sends a paging notification having a backoff-parameter-value range to the user equipment The user equipment receives the backoff-parameter-value range. The user equipment selects a backoff time according to the backoff-parameter-value range.

### CROSS-REFERENCE TO RELATED APPLICATIONS

The present application is a National Stage Application under 35 U.S.C. § 371 of International Patent Application No. PCT/EP2023/071459 filed on Aug. 2, 2023, and claims priority from German Patent Application No. 10 2022 208 044.0 filed on Aug. 3, 2022, in the German Patent and Trademark Office, the disclosures of which are herein incorporated by reference in their entireties.

### TECHNICAL FIELD

The application generally relates to wireless communications and, more particularly, to apparatuses and methods for improving Mobile Terminated-Small Data Transmission (MT-SDT) in a Radio Resource Control (RRC) inactive state.

### BACKGROUND

Because transitioning from an RRC Inactive or RRC idle state to an RRC connected state might cause overheads for a User Equipment (UE) when only a small amount of data is to be transmitted, 3^{rd} Generation Partnership Project (3GPP) has introduced technologies to optimize such small packets transmission. Indeed, UE needs to exchange multiple control signals to initiate and maintain a connection with a network. When payload size is relatively small compared with the amount of required control signals, establishing a connection becomes a concern for both the network and UE due to control signaling overhead.

Small Data Transmission (SDT) in RRC Inactive state has been introduced in 3GPP Release 17 for 5G NR to reduce signaling overhead and UE power consumption for infrequent data transmission. It allows UEs to transmit sporadic and small amount of data in RRC Inactive state, without requiring an RRC state transition.

The RRC Inactive state was introduced so as to keep the AS (Access Stratum) context at the base station and UE, with the aim of reducing energy consumption and the number of messages exchanged between a user equipment and a base station. In the RRC Inactive state, the user equipment and the base station suspend their radio connection, but the AS context is preserved in the user equipment and the base station.

Two types of SDT have been defined by 3GPP depending on how radio resources are configured: SDT using a random access (RA-SDT) and SDT using preConfigured Grant (CG-SDT). RACH (Random Access CHannel) based SDT allows SDT using an uplink grant received via a random access procedure for SDT. CG based SDT allows SDT from an RRC inactive state using a configured grant without performing a random access procedure.

Small Data Transmission using the preconfigured radio resource is referred to as transmission via PUR (Preconfigured Uplink Resource) in the LTE standards and CG-SDT (Configured Grant based SDT) in 5G NR standard. The base station configures radio resources when transiting the user equipment from RRC connected to RRC inactive state, for example in a RRC Release message including radio resource configuration for PUR of CG-SDT.

Small Data Transmission using the random access is referred to as an EDT (early data transmission) in LTE standard and RA-SDT (Random Access based SDT) in 5G NR (New Radio) standard. Data is transmitted using shared radio resources of the random access procedure.

Basically, when a base station needs to send a small amount of data to a user equipment in RRC Inactive state, it sends a paging notification to the user equipment. Such paging message is sent in SSB (Signal Synchronization Block) using QPSK (Quaternary Phase Shift Keying) modulation for Physical Downlink Control Channel (PDCCH), making it possible for the user equipment to decode the message even in low RSRP (Reference Signal Received Power) conditions. However, actual downlink data transmission may not be carried over a QPSK modulation and could be subject to errors in low RSRP conditions, leading to packets retransmissions and overheads.

The intension of this application is to specify the support for paging-triggered Mobile Terminated-Small Data Transmission (MT-SDT). On One hand MT-SDT triggering mechanism for UEs in RRC_INACTIVE, supporting RA-SDT and CG-SDT as the UL response; and the other hand Mobile Terminated-Small Data Transmission (MT-SDT) procedure for initial downlink (DL) data reception and subsequent uplink/downlink (UL/DL) data transmissions in RRC_INACTIVE.

Upon reception of Paging message, UE initiates RA (Random Access) procedure (i.e., either 2 step RA or 4-step RA) to receive small data transmission in RRC_INACTIVE

UE selects a preamble in the preamble group. gNB feedbacks a Random Access Response (RAR) to the UEs who sent preamble in Msg1/MsgA. In RAR, the gNB indicates a BI (Back-off Indicator) considering the cell load. Once the UE is failed in RA, e.g., the RAR doesn't include the preamble that UE sent in Msg1/MsgA, or the contention resolution in Msg4/MsgB is considered not successful, UE will randomly select a back-off time between 0 and BI and retransmit the preamble after the back-off time.

The current backoff time selection is that the UE selects one random backoff time between 0 and the backoff parameter value (BPV).

UEs with smaller backoff parameter value will select one backoff time between [0, small BPV] and the UEs with larger backoff parameter value will select one backoff time between [0, large BPV]. For example, if the BI field value is 10, Backoff Parameter value is 320 ms. This means UE can send PRACH any time in between 0 and 320 ms from now.

As lower range of backoff time is overlapped for all SDT UEs, more UEs will select backoff time in lower range of BPV.

As a result, there is a high possibilities of collision among multiple UEs during RACH procedure. Because of high possibilities of collision, UE might require more number of retransmission of PRACH which would result more power consumption and signaling overhead that is not desirable for small data.

According to backoff parameter value table in FIG. 9, for example, if UE1 receives BI value 10 at time T PRACH occasion, UE1 can send PRACH anytime in between 0 and 320 ms. If UE2 receives BI value 6 at time Δ+T PRACH occasion, UE2 can send PRACH anytime in between 0 and 80 ms. As a result, lower range of backoff time i.e., 0 to 80 ms is overlapped between UE1 & UE2 and there is a higher chance where UE1 can select backoff time between 0 and 80 ms.

This invention gives a solution for this described problem accordingly.

The application DE 10 2022 207 895 is incorporated by reference into this application.

Based on FIG. 9, when UE triggers RA procedure in RRC_INACTIVE, it selects BPV indicated in the paging message. gNB configures UE specific BPV range in the paging message based on UE's priority and the data volume threshold. gNB configures lower BPV for higher data volume threshold/higher data priority UEs and higher BPV for lower data volume threshold/lower data priority UEs. UE with higher data volume threshold/higher data priority owns highest RACH priority.

Benefit: UE selects specific back-off time based on the traffic characteristic instead of choosing it randomly. So, RACH congestion would reduce due to a non-overlap in backoff time. As a result, UE would not require to transmit more number of PRACH transmission, thus signaling overhead as well as power consumption would reduce.

### BRIEF SUMMARY

In one aspect, it is proposed a method for receiving Small Data Transmission by a user equipment device connected to a wireless communication network. The method comprises the following steps Receiving (203) a paging notification from a base station while in inactive state, the paging notification comprising at least:
User equipment (UE) specific backoff parameter value (BPV) range in the paging message based on user equipment's (UE's) priority and/or the data volume threshold
a configuration of lower backoff parameter value (BPV) for higher data volume threshold and/or higher data priority UEs and higher backoff parameter value (BPV) for lower data volume threshold and/or lower data priority User equipment (UEs).

This avoids transmitting non-urgent small data when poor network conditions are experienced, thus avoiding packet retransmissions and signaling overhead, while reducing power consumption.

According to another embodiment the method is characterized by that the user equipment (UE) with higher data volume threshold and/or higher data priority owns highest RACH priority.

According to another embodiment the method is characterized by, when the User equipment (UE) is not required to transmit more number of PRACH transmission, by which the signaling overhead is and/or the power consumption is reduced.

An aspect relates to an apparatus for receiving Small Data Transmission (SDT) from a base station in a wireless communication network, the apparatus comprising a wireless transceiver (704), a processor (601) coupled with a memory (602) in which computer program instructions (603) are stored, said apparatus being configured to perform a method as described above and/or below.

An aspect relates to a user equipment comprising an apparatus as described above and/or below.

An aspect relates to a method for performing Small Data Transmission by a base station in a wireless communication network, wherein the method comprises:
Transmitting (301) a paging notification (302) to a user equipment in inactive state, the paging notification comprising at least:
User equipment (UE) specific backoff parameter value (BPV) range in the paging message based on user equipment's (UE's) priority and/or the data volume threshold
a configuration of lower backoff parameter value (BPV) for higher data volume threshold and/or higher data priority UEs and higher backoff parameter value (BPV) for lower data volume threshold and/or lower data priority User equipment (UEs)

An aspect relates to an apparatus for performing Small Data Transmission in a wireless communication network, the apparatus comprising a wireless transceiver (704), a processor (701) coupled with a memory (702) in which computer program instructions (703) are stored, said apparatus being configured to perform a method as described above and/or below.

An aspect relates to a wireless communication system for performing small data transmission from a base station to a user equipment, wherein the base station comprises a processor coupled with a memory in which computer program instructions are stored, said communication system being configured to perform a method as described above and/or below, wherein the user equipment comprises a processor coupled with a memory in which computer program instructions are stored, configured to perform a method as described above and/or below.

One aspect relates to a method for transmitting Small Data Transmission, SDT, data from a base station, gNB, to a user equipment, UE, the method comprising the steps of:
setting the UE to an inactive state;
providing, by the gNB, the SDT data;
sending, from the gNB to the UE, a paging notification, the paging notification comprising a backoff parameter value, BPV, range;
receiving, by the UE, the BPV range; and
selecting, by the UE, a backoff time according to the BPV range.

The base station may be a 5G Base Station that uses New Radio (NR) technology. The base station may be designated as a gNB or gNodeB base station. The UE may be configured for supporting 5G protocols. The methods described above and/or below may preferably be applied to a UE that is in a so-called RRC_INACTIVE state, as defined by 3GPP. Definitions by 3GPP may also define conditions and circumstances for the UE to be set into said RRC_INACTIVE state. The gNB may be informed about the UE's RRC_INACTIVE state. When the UE is in RRC_INACTIVE state, data may be received by the gNB, which are suited to be sent as SDT data. Examples of such “SDT data candidates” (further called “SDT data” for simplicity) may be data sent by an Internet of Things (IoT) device, or any other kind of data where only a small amount of data is to be transferred.

When the UE is in RRC_INACTIVE state and SDT data are available, the gNB may send a so-called paging notification to the UE. The paging notification may comprise several types of data. One of them may be a BPV range, short for “a range of backoff parameter values (BPV)”. Said BPVs may be encoded by a so-called Back-off Indicator (BI) field. The BI field may be a 4-bit field as depicted in FIG. 9. For example, if the BI field value is 10, BPV is 320 ms. This indicates a possible time delay of between 0 ms and 320 ms, between PRACH and next PRACH. The BPV range may contain one or more BPVs. For instance, a BPV range of “(0, 7)” may define backoff parameter values between 0 ms and 120 ms, whereas a BPV range of “(7, 9)” may define backoff parameter values between 120 ms and 240 ms.

The UE, then, receives the BPV range—possibly encoded by a 2-tuple of BI-values—and selects a backoff time according to the BPV range, i.e. applies the BPV range or the range of backoff times, in order to prepare and/or to perform its next protocol steps. The next protocol steps may be to skip an SDT, as depicted, e.g., in FIG. 2. The next protocol steps may be to initiate and/or to perform a Random Access based SDT (RA-SDT), e.g. according to FIG. 3a, FIG. 3b, FIG. 4, or FIG. 8a.

This may advantageously lead to a lower congestion, e.g. because the UE selects a specific back-off time, instead of choosing it randomly. So, a RACH congestion may be reduced, due to a reduced or avoided overlap in backoff time. Furthermore, the UE may not require to transmit more than only one PRACH transmission, which may lead to a reduction of both signaling overhead and power consumption of the communication system, particularly of the UE, which is often equipped with a rechargeable battery.

In various embodiments, the selecting, by the UE, is only performed when the priority flag indicates a high priority and a radio signal quality is above a predefined threshold. Under other conditions, the selecting and/or further protocol steps may be skipped and/or postponed to a later point in time, e.g. by waiting for the next paging cycle. The priority flag may be a one-bit binary flag set to a value “1” by the base station when the received data is of high priority, or “0” for low priority. A high priority flag may be set depending on several factors, like data priority, data volume threshold, traffic pattern and/or further factors. The paging notification message may, e.g., include a one-bit PagingDLdataInformation field in the PagingUE-Identity data structure defined by 3GPP TS38.331 specification. The radio signal quality may be a function of the RSRP, Reference Signal Received Power, and/or may be indicated by a so-called radio quality flag. This may advantageously force urgent data to be sent and/or received, but may limit further the number of retransmissions, the signaling overhead and/or the power consumption of the system, particularly when poor network conditions are experienced.

In various embodiments, the method further comprises the step of performing, by the gNB, a Random Access based SDT (RA-SDT) with the backoff time for the PRACH transmission according to the BPV range. The PRACH transmission means a transmission via the Physical Random Access Channel, PRACH. Upon reception of the paging message, the UE may initiate a so-called RA procedure (RA; Random Access), for example a 2-step RA procedure or a 4-step RA procedure, to receive SDT in the RRC_INACTIVE state. This may advantageously have the effect that the UE is not required to conduct more than one PRACH transmission, thus leading to a further reduction of the signaling overhead and/or of the UE's power consumption.

In various embodiments, the BPV range is between zero and a first BPV-value BPV1 for a data volume of the SDT data above a predefined data volume threshold DV1, and the BPV range is between the first BPV-value BPV1 and a second BPV-value BPV2 for a data volume below the predefined data volume threshold DV1. Examples for DV1 may be in a magnitude of between 10 bytes and 1000 bytes, e.g. 100 bytes. Due to constraints and/or settings by the network and/or the UE, the data volume of the SDT may, additionally, have a general upper limit (“DV2”). In some embodiments, there may be one or more data volume thresholds between DV1 and DV2, which may lead to definition(s) of further respective BPV ranges.

In various embodiments, the BPV range is between zero and a first BPV-value BPV1 for a high UE priority, and the BPV range is between the first BPV-value BPV1 and a second BPV-value BPV2 for a low UE priority. The UE priority may be determined, e.g. by the network or the gNB, based on an amount of the latency, or of another QoS value, of the data, which can be guaranteed by the UE. The BPV range may be determined based on the UE priority alone, based on the data volume, based on both values and/or based on further values. This may lead to a higher priority for a higher UE priority and/or for a higher data volume.

An aspect relates to a method for transmitting Small Data Transmission, SDT, data by a base station, gNB, the method comprising the steps of:
providing the SDT data; and
when a user equipment, UE, is in an inactive state, sending a paging notification to the UE, the paging notification comprising a backoff parameter value, BPV, range.

In various embodiments, the method further comprises the step of: On a paging response, performing a Random Access based SDT (RA-SDT) with the backoff time for the PRACH transmission according to the BPV range.

An aspect relates to a method for receiving Small Data Transmission, SDT, data by a user equipment, UE, the method comprising the steps of:
setting the UE to an inactive state;
receiving a paging notification, the paging notification comprising a backoff parameter value, BPV, range; and
selecting a backoff time according to the BPV range.

An aspect relates to a wireless communication system, configured for transmitting Small Data Transmission, SDT, data from a base station, gNB, to a user equipment, UE, as described above and/or below.

An aspect relates to a base station, gNB, configured for transmitting Small Data Transmission, SDT, data as described above and/or below.

An aspect relates to a user equipment, UE, configured for receiving Small Data Transmission, SDT, data as described above and/or below.

An aspect relates to a non-transitory computer-readable storage medium having a program stored therein, which, when executed on a base station, gNB, which instructs the gNB to perform the method as described above and/or below.

An aspect relates to a non-transitory computer-readable storage medium having a program stored therein, which, when executed on a user equipment, UE, which instructs the UE to perform the method as described above and/or below.

In some embodiments, the various steps of the method for receiving Small Data Transmission by a user equipment and/or the method for sending Small Data Transmission by a base station are determined by instructions of computer programs.

Consequently, the disclosure further contemplates computer programs on an information medium, these programs being suitable to be implemented respectively in user equipment device and a base station, or more generally in a computer, these programs respectively comprising instructions adapted to implement the steps of the wireless communication methods respectively supported by a user equipment and performed by a base station disclosed herein.

These programs can use any programming language, and be in the form of source code, object code, or of code intermediate between source code and object code, such as in a partially compiled form, or in any other desirable form.

A further aspect contemplates an information medium readable by a computer comprising instructions of a computer program such as mentioned hereinabove.

The information medium may be any entity or device capable of storing the program. For example, the medium can comprise a storage means, such as a ROM (Read Only Memory), for example a CD ROM or a microelectronic circuit ROM, EEPROM (Electrically Erasable Programmable Read-Only Memory), FLASH memory or any magnetic recording means, for example a hard drive.

Moreover, the information medium may be a transmissible medium such as an electrical or optical signal, which may be conveyed via an electrical or optical cable, by radio or by other means. The program according to an embodiment of the invention may be downloaded from a network.

Alternatively, the information medium may be an integrated circuit into which the program is incorporated, the circuit being arranged to execute or to be used in the execution of the methods in question.

The advantages of apparatus, user equipment, base station, system, and corresponding computer programs and information mediums are identical to those presented in relation with the method for receiving Small Data and method of performing Small Data according to any one of the embodiments mentioned hereinabove.

### BRIEF DESCRIPTION OF THE DRAWINGS

Other advantages and characteristics of the invention will be more clearly apparent on reading the following description, given by way of simple illustrative and nonlimiting example, and the appended drawings.

FIG. 1 illustrates a wireless system comprising a user equipment and a base station in which aspects of the present disclosure may be practiced.

FIG. 2 is a diagram illustrating a UE-terminated low-priority small data transmission example in RRC Inactive state, according to an embodiment.

FIG. 3a is a diagram illustrating a UE-terminated high-priority small data transmission example in RRC Inactive state, according to an embodiment.

FIG. 3b is a diagram illustrating a UE-terminated high-priority small data transmission example in RRC Inactive state, according to an embodiment.

FIG. 4 is a flow chart depicting mains steps of a state machine suitable for implementing a method for receiving small data transmission by a user equipment according to an embodiment.

FIG. 5 is a flow chart showing mains steps of a state machine suitable for implementing a method for performing small data transmission by a base station according to an embodiment.

FIG. 6 is a block diagram showing a schematic architecture of an apparatus suitable to implement a method of wireless communication for receiving a Small Data Transmission (SDT) from a base station, according to an embodiment.

FIG. 7 is a block diagram showing a schematic architecture of an apparatus suitable to implement a method of wireless communication for performing a Small Data Transmission (SDT) to a user equipment, according to an embodiment.

FIGS. 8a and 8b are flow charts showing main steps of a state machine suitable for implementing a method for performing small data transmission by a base station and a User equipment according to further embodiments.

FIG. 9 shows the backoff parameter value table accordingly.

FIG. 10 shows an interrelation between a data volume of the SDT data and the BPV range.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

FIG. 1 shows an exemplary 5G New Radio (NR) wireless communication system 100 comprising a user equipment 101 and a base station 102 in which aspects of the present disclosure may be practiced. The wireless network 100 may be an LTE network or some other wireless network, such as LTE, 5G or NR network. The wireless network 100 may include one or more base stations 102. The base station 102 may be referred as BS, NB, eNodeB (or eNB), gNodeB (or gNB), an access point or the like, depending on the wireless standard implemented. Base station 102 provide radio communication coverage for a particular geographic area called “cell”.

User equipment 101 may be referred as a mobile station, a wireless terminal, or the like. In some examples, user equipment 101 may be a cellular phone, a wireless modem, a wireless communication device, a handheld device, a laptop computer or the like. User equipment 101 may also be an IoT (internet of things) device, like wireless camera, a smart sensor or smart meter, a vehicle, a global positioning system device, or any other device configured to communicate through a wireless network.

User equipment 101 may support various communication modes, such as a connected mode (RRC Connected), an inactive mode (RRC Inactive), or an idle mode (RRC Idle) as defined by 3GPP. When operating in RRC Connected mode, user equipment 101 is active and communicate with base station 102. User equipment 101 may transition from communication mode to another using various commands and messages received from the base station 102. For example, User equipment 101 may switch from RRC Connected state to RRC Inactive state upon receiving a RRC Release message including suspendConfig parameter.

User equipment 101 may enter RRC Inactive state without completely releasing radio resources when there is no traffic, in order to quickly switch back to RRC Connected states when necessary. In this case, user equipment and base station may store a context for the user equipment, for example an access stratum (AS) context, in order to apply said stored context when transitioning from RRC Inactive to RRC Connected state and thus reduce latency and signaling overhead. Such context may include Radio configuration parameters, such as uplink grant, RNTI (Radio Network Temporary Identifier), MCS and/or the like.

However, radio conditions may have changed while user equipment 101 is RRC Inactive state, for example user equipment 101 may have moved to another location, thus altering channel quality.

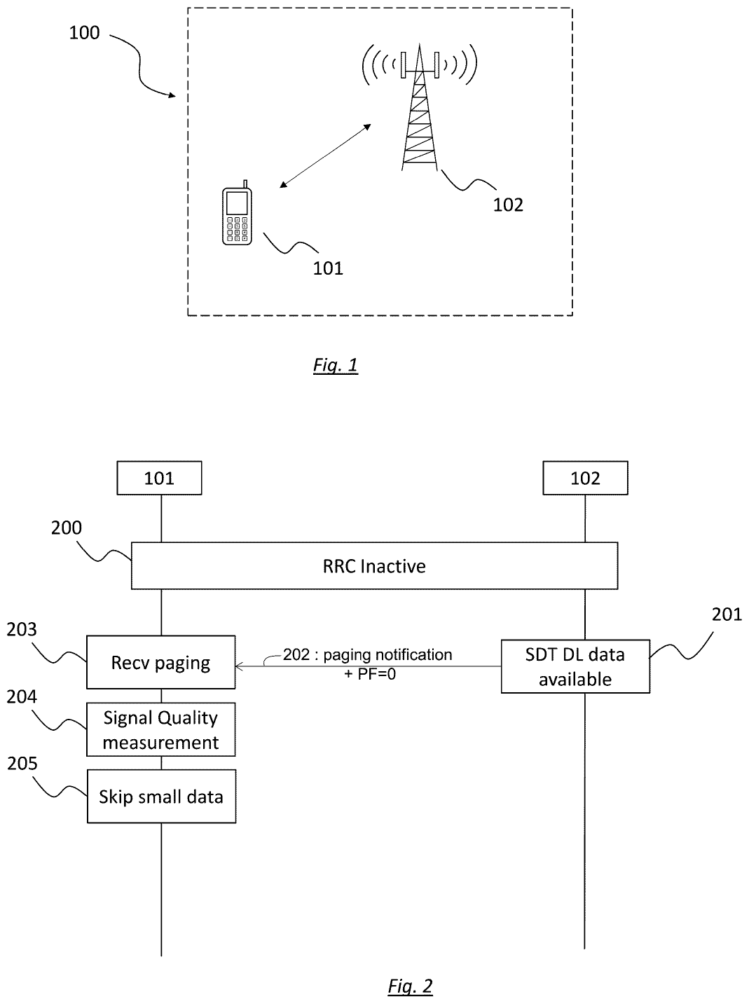

FIG. 2 is a diagram illustrating a UE-terminated low-priority small data transmission example in RRC Inactive state, according to an embodiment.

During a preliminary step 200, user equipment 101 may switch to RRC inactive state in response to a RRC Release message with suspendConfig parameter. An I-RNTI (Inactive Radio Network Temporary Identifier), may be allocated to user equipment 101 within such RRC Release message as part of suspendConfig parameter.

While user equipment 101 is in RRC Inactive state, the base station 102 may receive, at step 201, downlink small data destinated to user equipment 101. The downlink data may include a small amount of data like keep-alive packets, sensor data, push notifications, location data, etc. Base station 102 may transmit a paging notification 202 to user equipment 101 to inform about available downlink data, the paging notification comprising at least an identifier associated to the user equipment 101, for example an I-RNTI.

In some embodiments, the paging notification comprises an indication that downlink small data is available for transmission, and a priority flag associated with said downlink small data. The priority flag may be a one-bit binary flag set by base station 102 when the received data is of high priority. A high priority flag may be set depending on several factors, like data priority, data volume threshold, traffic pattern or the like. In some examples, the paging notification message may include a one-bit PagingDLdataInformation field in the PagingUE-Identity data structure defined by 3GPP TS38.331 specification.

User equipment 101 receives the paging notification 202 at step 203 and decodes the priority flag set by the base station 102.

At step 204, user equipment 101 may determine at least a Synchronization Signal Reference Signal Received Power.

According to an embodiment, if user equipment receives “0” in the paging message 202 (i.e., low priority data), and if all SSB's RSRP determined at step 204 are below a preconfigured threshold, it may skip Random Access (RA) procedure and go back to sleep mode at step 205 and wake up in the next paging cycle. The threshold may be a RSRP threshold defined by 3GPP.

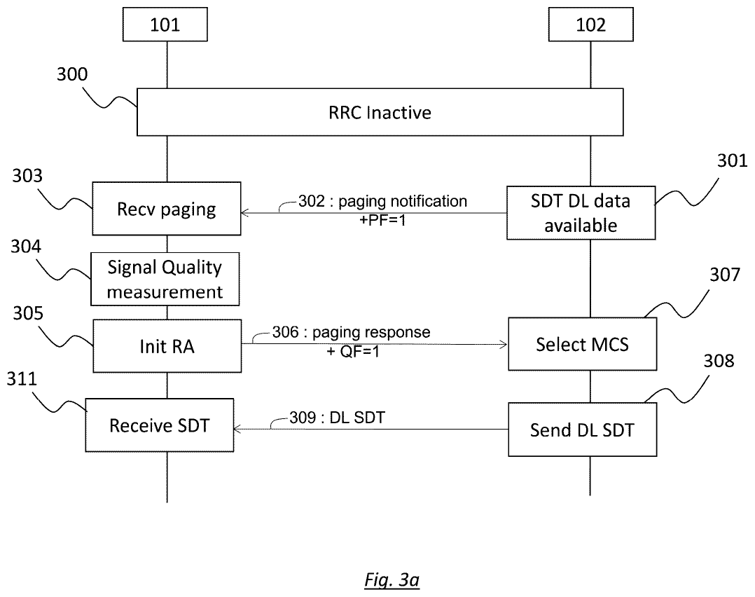

FIG. 3a is a diagram illustrating a UE-terminated high-priority small data transmission example in RRC Inactive state, according to an embodiment.

During a preliminary step 300, user equipment 101 may switch to RRC inactive state in response to a RRC Release message with suspendConfig parameter. An I-RNTI (Inactive Radio Network Temporary Identifier), may be allocated to user equipment 101 within such RRC Release message as part of suspendConfig parameter.

While user equipment 101 is in RRC Inactive state, the base station 102 may receive, at step 301, downlink small data destinated to user equipment 101. The downlink data may include a small amount of data like keep-alive packets, sensor data, push notifications, location data, etc. Base station 102 may transmit a paging notification 302 to user equipment 101 to inform about available downlink data, the paging notification comprising at least an identifier associated to the user equipment 101, for example a I-RNTI.

In some embodiments, the paging notification 302 may comprise an indication that downlink small data is available for transmission, and a priority flag associated with said downlink small data. In some examples, said priority flag may be a one-bit PagingDLdataInformation field included in the PagingUE-Identity data structure defined by 3GPP TS38.331 specification.

The priority flag may be a one-bit binary flag set by base station 102 when the received data is of high priority. A high priority flag may be set depending on several factors, like data priority, data volume threshold, traffic pattern or the like. In the example of FIG. 3a, the paging notification 302 comprises a priority flag set to “1”, indicating that high priority data is pending.

User equipment 101 receives the paging notification 302 at step 303 and decodes the priority flag set by the base station 102.

At step 304, user equipment 101 may determine at least a Synchronization Signal Reference Signal Received Power (SSB RSRP). In the example of FIG. 3a, it is considered that all SSB's RSRP are below a threshold (i.e., bad radio quality is experienced).

If user equipment 101 receives “1” in the paging notification message, meaning that high priority data is pending, it may trigger RA-SDT or CG-SDT procedure at step 305 and inform base station 102 about SSB's RSRP result is below the threshold through 2-step RACH/4-step RACH/CG. Base station 102 may be informed of SSB's RSRP being below the threshold in a message 306. In some examples, a radio quality flag (e.g., a bit, or a CQI Index) may be set in message 306 to indicate SSB's RSRP determined at step 304 is below the threshold.

According to an embodiment, base station 102 may receive the paging response 306 at step 307 and, based on the received flag, it may select a lower/more robust modulation scheme to transmit data to user equipment 101. Base station 102 may send Small Data at step 308 in a message 309 using a MCS selected at step 307. This way, urgent data may be received by user equipment 101 at step 311 while limiting the risk of retransmission, signaling overhead and power consumption when poor radio conditions are experienced by user equipment 101.

According to an embodiment shown on FIG. 3b, instead of selecting a low MCS based on received quality flag at step 307 and send Small Data at step 308, base station 102 may take a skip decision at step 311 when quality flag indicates that all SSB's RSRP are below a threshold and schedule DL SDT in the next paging cycle. During step 312, base station 102 may configure a second wake up cycle using a message 313, for example msgB (2 step RACH) or msg4 (4 step RACH) or MAC CE (in case of Configured Grant (CG)) if it decides to skip downlink SDT. User equipment may then configure at step 314 a wake up according to the second wake up cycle to receive downlink small data. This way, base station 102 may avoid sending data when no SSB RSRP has suitable quality, thus limiting the risk of retransmission and signaling overhead.

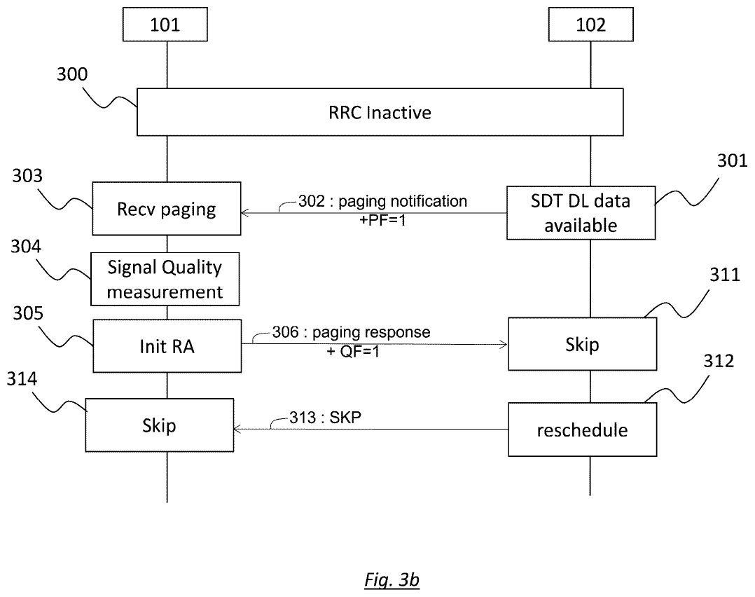

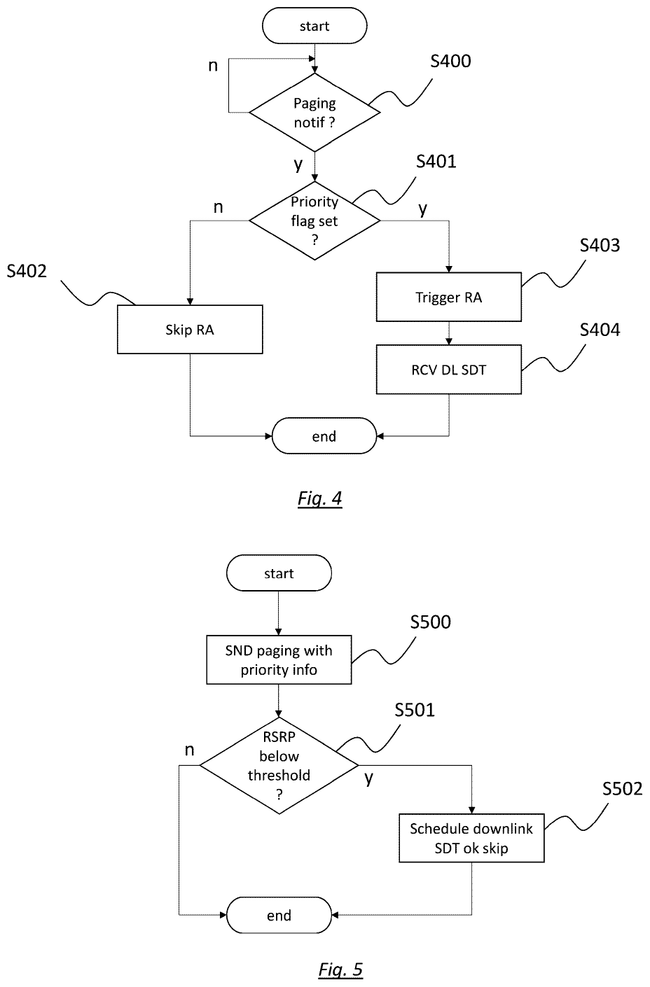

FIG. 4 is a flow chart depicting mains steps of a state machine suitable for implementing a method for receiving small data transmission by a user equipment according to an embodiment.

At step S400, user equipment waits for a paging notification while in RRC inactive state. Upon reception of a paging notification indicating that Small Data is available for transmission at the serving base station, the user equipment decodes the received notification and checks whether a priority flag is included and the value of said priority flag at step S401. When priority flag is included in the received paging notification and indicates that pending small data is of low priority, then user equipment may skip random access procedure at step S402 and wait for next paging cycle.

On the other hand, when it is found at step S401 that pending data is of high priority, user equipment triggers random access procedure and indicates base station that SSB's RSRP is below a threshold at step S403 and receives downlink SDT during step S404 on a low MCS configured by base station based on said RSRP indication or, in an alternate embodiment, receive an indication of skipping downlink data until next paging cycle.

FIG. 5 is a flow chart showing mains steps of a state machine suitable for implementing a method for performing small data transmission by a base station according to an embodiment.

At step S500, base station may receive some small data to send to a user equipment which is in RRC inactive state. Base station may prepare a paging notification comprising an indication regarding the priority of the data to send as already described hereinabove and send the paging notification to user equipment.

At step S501, base station may receive a message from user equipment in response to the paging notification. Said message may comprise a flag indicating whether all SSB's RSRP are below a preconfigured threshold.

When said flag indeed indicates to the base station that all SSB's RSRP are below the threshold, base station may perform step S502 during which base station may decide to schedule the SDT in a further paging cycle, or to perform data transmission using a low MCS.

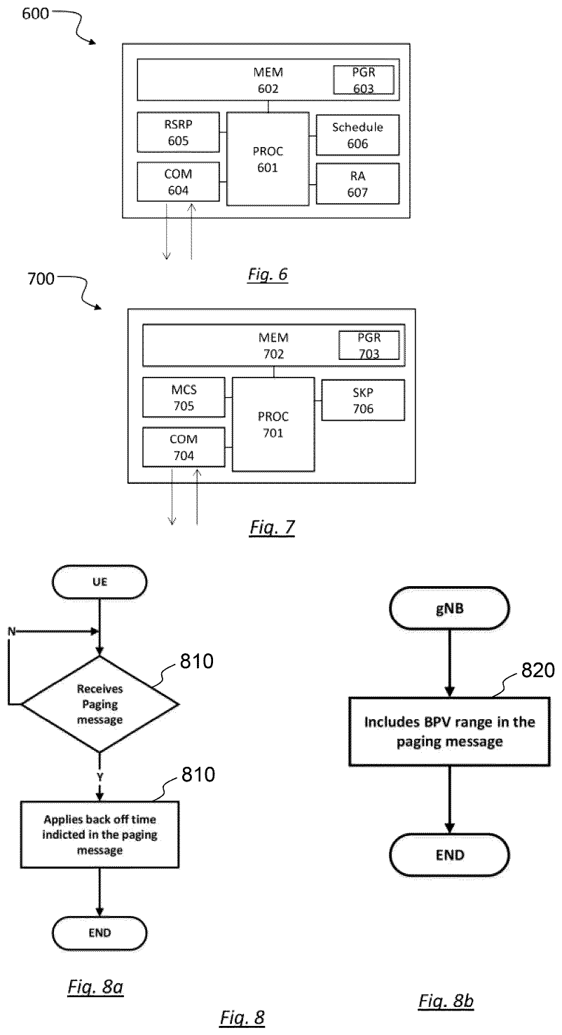

FIG. 6 is a block diagram showing a schematic architecture of an apparatus 600 suitable to implement a method of wireless communication for receiving a Small Data Transmission (SDT) from a base station, according to an embodiment.

The apparatus 600 comprises a processor 601 and a memory 602, for example a Random Access Memory (RAM). The processor 601 may be controlled by a computer program 603 stored in the memory 602 comprising instructions configured to implement a method for receiving Small Data Transmission (SDT) from a base station in a wireless communication network.

More precisely, the computer program 603 comprises instructions for receiving a paging notification from a base station while in inactive state, the paging notification comprising at least an indication that downlink small data is available for transmission, and a priority flag associated with said downlink small data, to determine at least a Synchronization Signal Reference Signal Received Power, and to postpone downlink data reception until next paging cycle when said priority flag indicates low priority downlink data and said at least a Synchronization Signal Reference Signal Received Power is below a threshold.

On initialization, instructions of the computer program 603 may be loaded into the memory 602 before being executed by the processor 601. The processor 601 implements the steps of the method according to the instructions of the computer program 603.

The apparatus 600 comprises a wireless communication unit 604, for example a 3G, 4G, 5G, 5G NR, WiFi or WiMax transceiver for exchanging messages with other apparatus. In particular, communication unit 604 is configured by program instructions to receive a paging notification broadcasted by a base station and check if the received paging is addressed to the apparatus by comparing an identifier comprised in said paging notification with an identifier associated with the apparatus. The communication unit 605 may be further configured to obtain an indication from said paging notification, regarding a priority associated with available small data. This indication may be a binary flag included in a PagingUE-Identity data field of the paging notification wherein the flag is set to indicate high priority small data.

The apparatus 600 further comprises a channel quality sensor 605. The channel quality sensor may be configured by computer program instructions to measure the signal strength on one or more available SSBs (Synchronization Signal Blocks), and to compare the measured values to a preconfigured threshold to determine whether all SSB's RSRP are below said threshold value.

According to an embodiment, the apparatus 600 further comprises a scheduler unit 606. The scheduler unit 606 may be configured by computer program instructions to postpone downlink data reception until next paging cycle when said priority flag received by communication unit 604 indicates low priority downlink data and when the channel quality sensor 605 determines that said measured all SSB's RSRP are below said threshold.

In some embodiments, the apparatus 600 may comprise a random access module 607 configured by computer program instructions to initiate a Random Access Procedure. The Random Access Procedure may include the sending through the communication unit 604 of a quality indicator determined by the channel quality sensor 605 to the serving base station. In some examples, the quality indicator is sent as a binary flag which is set to indicate that all SSB's RSRP are below a preconfigured threshold.

According to an embodiment, the communication unit 604 is further configured by computer program instructions to receive downlink data from the base station, said downlink data being transmitted using a low modulation scheme selected by said base station based on said at least a Synchronization Signal Reference Signal Received Power is below a threshold.

In some embodiments, the apparatus 600 is included in a user equipment device, like a smartphone, a laptop, an IoT (Internet of Things) device or a vehicle.

FIG. 7 is a block diagram showing a schematic architecture of an apparatus 700 suitable to implement a method of wireless communication for performing a Small Data Transmission (SDT) to a user equipment, according to an embodiment.

The apparatus 700 comprises a processor 701 and a memory 702, for example a Random Access Memory (RAM). The processor 701 may be controlled by a computer program 703 stored in the memory 702 comprising instructions configured to implement a method for receiving Small Data Transmission (SDT) from a base station in a wireless communication network.

More precisely, the computer program 703 comprises instructions configured to transmit a paging notification to a user equipment in inactive state, the paging notification comprising at least an indication that downlink small data is available for transmission, and a priority flag associated with said downlink small data, to receive a paging response comprising at least an indication that at least a Synchronization Signal Reference Signal Received Power is below a threshold, and to transmit downlink data using a modulation scheme selected based on said Synchronization Signal Reference Signal Received Power indication received.

On initialization, instructions of the computer program 703 may be loaded into the memory 702 before being executed by the processor 701. The processor 701 implements the steps of the method according to the instructions of the computer program 703.

The apparatus 700 comprises a wireless communication unit 704, for example a 3G, 4G, 5G, 5G NR, WiFi or WiMax transceiver for exchanging messages with other apparatus. In particular, communication unit 704 is configured by program instructions to transmit a paging notification to a user equipment in inactive state, when small data is available for download, the paging notification comprising at least an indication that downlink small data is available for transmission, and a priority flag associated with said downlink small data. According to an embodiment, said indication may be a binary flag included in a PagingUE-Identity data field of the paging notification wherein the flag is set to indicates high priority small data.

The wireless communication unit 704 may be further configured by computer program instructions to receive a response to said paging notification from a user equipment and for obtaining, from said response received, a quality indicator representative of whether all SSB's RSRP measured by said user equipment are below a preconfigured threshold value.

In some embodiments, the apparatus 700 further comprise a modulation scheme selector module 705. The MCS selector module may be configured by computer program instructions to select a low MCS when the quality indicator representative received by the communication unit 704 indicates that all SSB's RSRP determined by the user equipment are below a preconfigured threshold value.

The communication unit 704 may be further configured by computer program instructions to transmit downlink data using a MCS selected by the MCS selector module 705; i.e., to transmit small data using a low MCS when all SSB's RSRP measured by user equipment are below the threshold.

According to an embodiment, the apparatus 700 may comprise a skip module 706 configured to skip small data transmission and schedule it in a next paging cycle when the received quality indicator indicates that all SSB's RSRP are below the threshold.

In some embodiment, the apparatus 700 is included in a base station, like a gNodeB or an eNodeB.

FIGS. 8a and 8b are flow charts showing main steps of a state machine suitable for implementing a method for performing small data transmission by a base station and a User equipment according to further embodiments,

Another embodiment is an example for a based on Data Volume approach.
gNB configures backoff parameter range for Data Volume (DV1) as [BPV1, BPV2] and backoff parameter range for DV2 as [0, BPV1] where DV1 <DV2;
If gNB wants to transmit total amount of data to the UE below DV1, it configures backoff time between BPV1 and BPV2 in the paging message;
UE selects back off time between BPV1 and BPV2;
If gNB wants to transmit total amount of data to the UE above DV1, it selects backoff time between 0 and BPV1;
UE selects back off time between 0 and BPV1;
PRACH transmission is prioritized for UEs who receive higher data volume.

Another embodiment is an example for based on Data Priority approach.
gNB configures backoff parameter range for Data Volume (DV1) as [BPV1, BPV2] and backoff parameter range for DV2 as [0, BPV1] where DV1 <DV2;
If gNB wants to transmit total amount of data to the UE below DV1, it configures backoff time between BPV1 and BPV2 in the paging message;
UE selects back off time between BPV1 and BPV2;
If gNB wants to transmit total amount of data to the UE above DV1, it selects backoff time between 0 and BPV1;
UE selects back off time between 0 and BPV1;
PRACH transmission is prioritized for UEs who receive higher data volume.

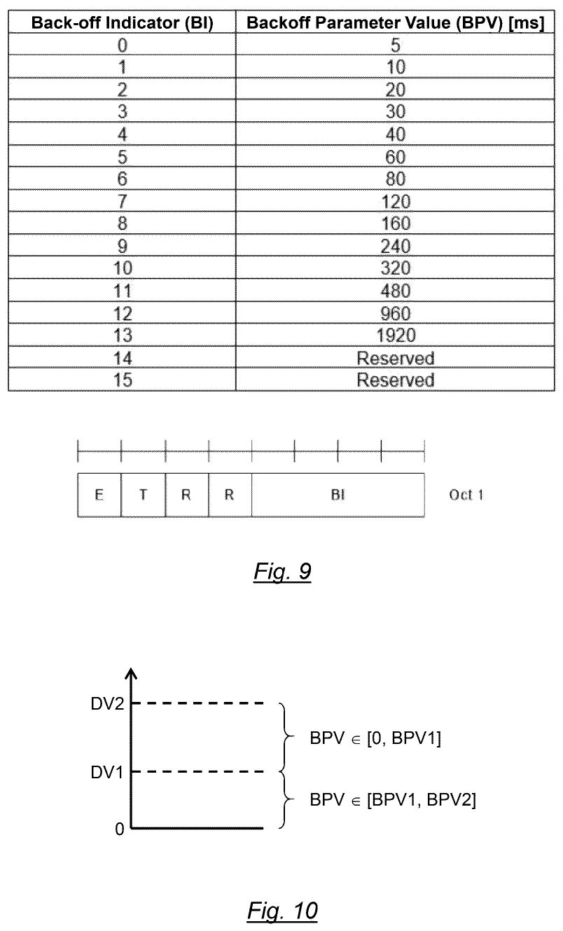

FIG. 9 shows the backoff parameter value table accordingly.

FIG. 10 shows an interrelation between a data volume of the SDT data and the BPV range according to an embodiment. The y-axis of the diagram depicts the data volume, with data volumes 0 (zero), DV1 and DV2. In cases when the data volume of the SDT data is above the predefined data volume threshold DV1, the BPV range is between zero and a first BPV-value BPV1. In cases when the data volume of the SDT data is below the predefined data volume threshold DV1, the BPV range is between the first BPV-value BPV1 and a second BPV-value BPV2.

Both last cited approaches of the embodiments can be combined together with all the others disclosed accordingly.

This feature is most beneficial for sensors, IoT devices, and even messaging and presence applications in smartphones.

1. A method for transmitting Small Data Transmission, SDT, data from a base station, gNB, to a user equipment, UE, the method comprising the steps of:
setting the UE to an inactive state;
providing, by the gNB, the SDT data;
sending, from the gNB to the UE, a paging notification, the paging notification comprising a backoff parameter value, BPV, range;
receiving, by the UE, the BPV range; and
selecting, by the UE, a backoff time according to the BPV range.

2. The method of claim 1,
wherein the selecting, by the UE, is only performed when the priority flag indicates a high priority and a radio signal quality is above a predefined threshold.

3. The method of claim 1, further comprising:
performing, by the gNB, a Random Access based SDT with the backoff time for the PRACH transmission according to the BPV range.

4. The method of claim 1, wherein the BPV range is between zero and a first BPV-value for a data volume of the SDT data above a predefined data volume threshold, and the BPV range is between the first BPV-value and a second BPV-value for a data volume below the predefined data volume threshold.

5. The method of claim 1, wherein the BPV range is between zero and a first BPV-value for a high UE priority, and
the BPV range is between the first BPV-value and a second BPV-value for a low UE priority.

6. A method for transmitting Small Data Transmission, SDT, data by a base station, gNB, the method comprising:
providing the SDT data; and
when a user equipment, UE, is in an inactive state, sending a paging notification to the UE, the paging notification comprising a backoff parameter value, BPV, range.

7. The method of claim 6, further comprising: on a paging response, performing a Random Access based SDT with the backoff time for the PRACH transmission according to the BPV range.

8. A method for receiving Small Data Transmission, SDT, data by a user equipment, UE, the method comprising:
setting the UE to an inactive state;
receiving a paging notification, the paging notification comprising a backoff parameter value, BPV, range; and
selecting a backoff time according to the BPV range.

9. A wireless communication system, configured for transmitting Small Data Transmission, SDT, data from a base station, gNB, to a user equipment, UE, the wireless communication system being configured to perform operations comprising:
setting the UE to an inactive state;
providing, by the gNB, the SDT data;
sending, from the gNB to the UE, a paging notification, the paging notification comprising a backoff parameter value, BPV, range;
receiving, by the UE, the BPV range; and
selecting, by the UE, a backoff time according to the BPV range.

10. A base station, gNB, configured for transmitting Small Data Transmission, SDT, data, the base station being configured to perform operations comprising:
providing the SDT data; and
when a user equipment, UE, is in an inactive state, sending a paging notification to the UE, the paging notification comprising a backoff parameter value, BPV, range.

11. A user equipment, UE, configured for receiving Small Data Transmission, SDT, data, the user equipment being configured to perform operations comprising:
setting the UE to an inactive state;
receiving a paging notification, the paging notification comprising a backoff parameter value, BPV, range; and
selecting a backoff time according to the BPV range.

12. A non-transitory computer-readable storage medium having computer-executable instructions stored therein, which, when executed by a processor of a base station, gNB, cause the gNB to perform operations comprising:
providing the SDT data; and
when a user equipment, UE, is in an inactive state, sending a paging notification to the UE, the paging notification comprising a backoff parameter value, BPV, range.

13. A non-transitory computer-readable storage medium having computer-executable instructions stored therein, which, when executed by a processor of a user equipment, UE, cause the UE to perform operations comprising:
setting the UE to an inactive state;
receiving a paging notification, the paging notification comprising a backoff parameter value, BPV, range; and
selecting a backoff time according to the BPV range.
